(19) United States
(12) Patent Application Publication
(10) Pub. No.: US 2026/0368003 A1
(43) Pub. Date: Nov. 19, 2026

(54) APPLICATION-PROGRAMMING INTERFACE SPECIFICATION OF ARTIFICIAL INTELLIGENCE CONTEXT PROTOCOL ENDPOINT

(71) Applicant: Microsoft Technology Licensing, LLC, Redmond, WA (US)

(72) Inventors: Marc A GOODNER, Kirkland, WA (US); Brian Scott KRABACH, Snohomish, WA (US)

(73) Assignee: Microsoft Technology Licensing, LLC, Redmond, WA (US)

(21) Appl. No.: 19/211,062

(22) Filed: May 16, 2025

(51) Int. Cl. G06F 9/54

(52) U.S. Cl. CPC G06F 9/541

(57) ABSTRACT

A computing system including one or more processing devices configured to, by executing one or more machine learning (ML) models, generate an application-programming interface (API) specification of an APIs respectively associated with an artificial intelligence context protocol (AICP) endpoint. The one or more processing devices generate an API call based at least on the API specification. The one or more processing devices execute the API call to communicate with the AICP endpoint and receive an AICP response. The one or more processing devices compute API monitoring data. At least by executing the one or more ML models, the one or more processing devices generate a modified API specification based at least in part on the API specification and the API monitoring data. The one or more processing devices generate and execute a modified API call based at least in part on the modified API specification.

### BACKGROUND

Many recent advances in the field of machine learning (ML) have integrated ML models with other tools and resources that extend the capabilities of an ML system beyond those offered by the ML models alone. For example, an ML model may be equipped with scaffolding code that selectively calls the ML model with programmatically specified inputs and controls communication between the ML model and other computing processes. For example, an ML system that includes one or more scaffolded ML models may be used to perform actions at a separate application program (e.g., a web browser or a spreadsheet program) or to access external data sources when constructing ML model prompts.

### SUMMARY

According to one aspect of the present disclosure, a computing system is provided, including one or more processing devices configured to, at least in part by executing one or more machine learning (ML) models included in a generative system, generate an application-programming interface (API) specification of an API respectively associated with an artificial intelligence context protocol (AICP) endpoint. The one or more processing devices are further configured to generate an API call based at least in part on the API specification. The one or more processing devices are further configured to execute the API call to communicate with the AICP endpoint. The one or more processing devices are further configured to receive an AICP response to the API call from the AICP endpoint. The one or more processing devices are further configured to compute API monitoring data that includes one or more performance properties of executing the API call. At least in part by executing the one or more ML models, the one or more processing devices are further configured to generate a modified API specification based at least in part on the API specification and the API monitoring data. The one or more processing devices are further configured to generate a modified API call based at least in part on the modified API specification. The one or more processing devices are further configured to execute the modified API call.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which an artificial intelligence context protocol (AICP) is implemented, according to one example embodiment.

FIG. 2 schematically shows the computing system during computation of an application-programming interface (API) specification and an API call, according to the example of FIG. 1.

FIG. 3 schematically shows the computing system during programmatic modification of the API specification, according to the example of FIG. 2.

FIG. 4 schematically shows the computing system in an example in which the one or more processing devices are configured to compute the API call based at least in part on a query received at a user interface, according to the example of FIG. 2.

FIG. 5 schematically shows the computing system in an example in which the one or more processing devices are configured to programmatically execute a plurality of specification updating iterations, according to the example of FIG. 2.

FIG. 6A shows a flowchart of a method for use with a computing system to programmatically make API calls over an AICP, according to the example of FIG. 1.

FIGS. 6B-6E show additional steps of the method of FIG. 6A that may be performed in some examples.

FIG. 7 shows a schematic view of an example computing environment in which the computing system of FIG. 1 may be instantiated.

### DETAILED DESCRIPTION

Artificial intelligence context protocols (AICPs) have recently been developed to allow ML systems to exchange inputs and outputs with external tools and resources in a consistent and standardized manner. An AICP is an application layer protocol in the open services interconnection (OSI) model of client-server communications that facilitates interaction between ML systems, as clients, and external services, as servers. An AICP endpoint refers to a server program operating at a network address that is configured with an application-programming interface (API) for the external service. The external service is thus a hosted application at the endpoint. The service is external to the ML system but may be hosted locally on the same computing device or remotely on a separate computing device. An AICP provides a shared communication framework by which data such as ML model contexts and inferencing outputs may be exchanged between an AICP client that executes the ML system and one or more AICP servers outside the ML system. Model Context Protocol (MCP) is an example of an AICP that has recently seen increased adoption among providers both of ML systems and of external tools made available to those ML systems. The AICP standardizes how ML models interact with external data sources, tools, and services.

When a generative system that includes one or more ML models interacts with an external tool or resource over an AICP, that generative system may provide instructions to that external tool using an application-programming interface (API). The API provides a set of available interactions between the external tool and other computing processes. The one or more ML models may process code of the API when determining what actions to invoke at an external application via an AICP request. For example, a generative language model may be used to compute one or more API calls.

When one or more API calls are computed at a generative language model, the entire API may be too long for the one or more ML models to process efficiently and obtain relevant outputs. For example, the number of tokens included in the API code may surpass the context window size of an ML model included in the generative system. Even when the context window is large enough to accommodate the entire API, processing the large number of tokens included in the API may result in high latency. The API may also include code specifying actions that are irrelevant to interactions with the generative system. Thus, reliable interaction with an external tool over an API may be difficult to achieve.

Although a static list of actions performable via the API may be used to avoid overloading the context window of an ML model, such a static list is inflexible and does not account for differences in users' patterns of interaction with the generative system and the external tool. In addition, the static list of API functions may have to be adjusted manually by a developer whenever the API is updated.

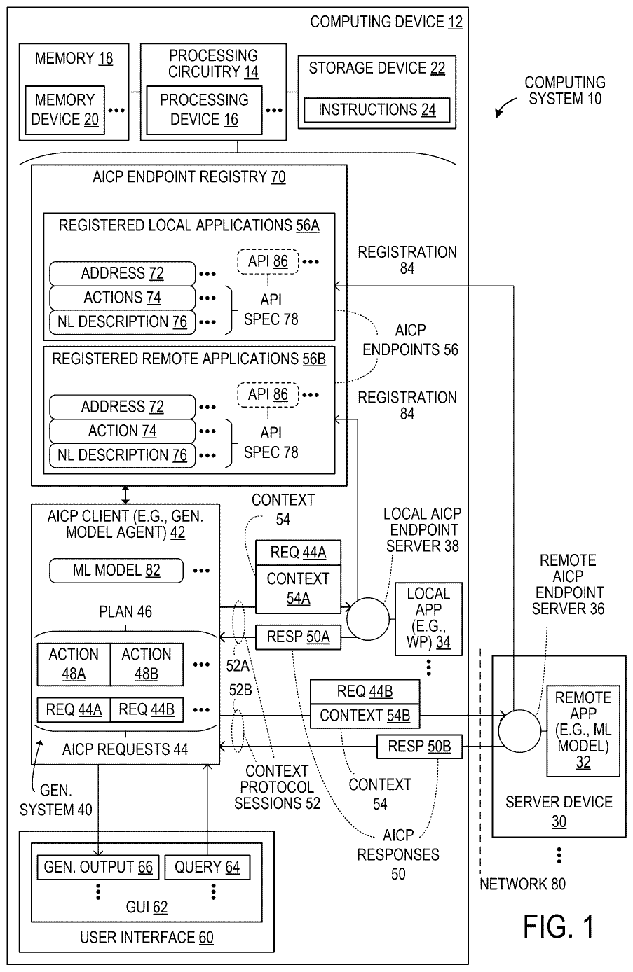

FIG. 1 schematically shows a computing system 10 at which an AICP is implemented. The computing system 10 includes a computing device 12 having processing circuitry 14, memory 18, and a storage device 22 storing instructions 24 that enable the processing circuitry 14 to perform the functions described herein. The processing circuitry 14 includes one or more processing devices 16, which may, for example, include one or more central processing units (CPUs), graphics processing units (GPUs), neural processing units (NPUs), and/or other specialized hardware accelerator devices. The memory 18 may include one or more memory devices 20.

While illustrated as a single computing device 12 in FIG. 1, it will be understood that the computing device 12 can be a distributed computing device 12, and that the processing circuitry 14, memory 18, and storage device 22 of this implementation may be distributed among a plurality of physical devices connected by a computer network, with coordinated operations being performed among these devices in a distributed computing environment. For example, in a virtualized environment, storage, processing, and memory can be implemented on different physical machines. As another example, computing device 12 may utilize client software that interacts with cloud services. Thus, one or more functions described herein may be executed on a remote server.

The one or more processing devices 16 included in the computing device 12 are configured to execute a generative system 40 at an AICP client 42. The generative system 40 includes one or more ML models 82, such as one or more generative language models, text-to-image (T2I) models, image-to-text (I2T) models, audio generation models, audio transcription models, classifier models, multimodal ML models, and/or other types of ML models. The generative system 40 may further include scaffolding code associated with the one or more ML models 82. For example, the scaffolding code may be executed to select one or more of the ML models 82 from among a plurality of ML models 82 included in the generative system 40. The scaffolding code may additionally or alternatively be executed to specify a context used as an inferencing input to an ML model 82, and/or to post-process an inferencing output.

In the example of FIG. 1, the computing device 12 is a client computing device that is configured to communicate with a server device 30 over a network 80. The AICP client 42 is configured to transmit AICP request 44 to a remote application 32 executed at the server device 30 and is configured to receive AICP responses 50 from that remote application 32. In some examples, the AICP client 42 may additionally be configured to communicate with one or more local applications 34 hosted at the computing device 12. For example, the local application 34 may be a word processing program and the remote application 32 may be a remotely hosted ML model.

In the example of FIG. 1, the server device 30 and the computing device 12 are accordingly configured to instantiate a remote AICP endpoint server 36 and a local AICP endpoint server 38, respectively, as virtual endpoint servers of the AICP. The one or more processing devices 16 are configured to instantiate a plurality of context protocol sessions 52 in this example. The AICP client 42 is configured to communicate with the local AICP endpoint server 38 over a first context protocol session 52A and communicate with the remote AICP endpoint server 36 over a second context protocol session 52B.

In the example of FIG. 1, the one or more processing devices 16 are further configured to implement a user interface 60 at which the user communicates with the generative system 40 using one or more input devices and one or more output devices. For example, the user interface 60 may include a graphical user interface (GUI) 62. One or more other input modalities and/or output modalities, such as speech input and audio output, may also be exchanged at the user interface 60 in some examples. At the user interface 60, the one or more processing devices 16 are configured to receive one or more queries 64 entered by the user. In response to the one or more queries 64, the one or more processing devices 16 are further configured to compute one or more generated outputs 66 at the generative system 40 and output the one or more generated outputs 66 to the user interface 60. For example, the user interface 60 may be presented in a chat format in which the user and the generative system 40 exchange the one or more queries 64 and the one or more generated outputs 66 as conversational turns.

The generative system 40, in the example of FIG. 1, is configured to compute a plan 46 at least in part at the one or more ML models 82 in response to receiving a query 64 from the user interface 60. For example, the plan 46 may be computed at a generative language model configured to generate computer code. The example plan 46 shown in FIG. 1 includes a first action 48A and a second action 48B that the one or more processing devices 16 are configured to execute at least in part by communicating with the local AICP endpoint server 38 and the remote AICP endpoint server 36. For example, the generative system 40 may compute the plan 46 in response to a user query that includes a link to a text document and an instruction “highlight all the passages in this document that have spelling mistakes, grammatical mistakes, or unclear wording.” In this example, the first action 48A may be executed at least in part at a locally hosted word processing application and the second action 48B may be executed at least in part at a remotely hosted generative language model. In some examples, the first action 48A and the second action 48B are natural-language indications of types of API calls.

At the AICP client 42, the one or more processing devices 16 are further configured to compute AICP requests 44 including a first AICP request 44A and a second AICP request 44B. Over the first context protocol session 52A and the second context protocol session 52B, respectively, the one or more processing devices 16 are further configured to transmit the first AICP request 44A to the local AICP endpoint server 38 and transmit the second AICP request 44B to the remote AICP endpoint server 36. The one or more processing devices 16 are further configured to compute context 54 at the generative system 40 and transmit that context 54 to the endpoint servers. For example, the context 54 may include data indicated as an inferencing input for an ML model located at an AICP endpoint server. Additionally or alternatively, the context 54 may include at least a portion of the plan 46. In the example of FIG. 1, the first AICP request 44A is transmitted to the local AICP endpoint server 38 along with a first context 54A, and the second AICP request 44B is transmitted to the remote AICP endpoint server 36 along with a second context 54B.

The AICP client 42 is further configured to receive AICP responses 50 including a first AICP response 50A and a second AICP response 50B. The first AICP response 50A is received from the local AICP endpoint server 38 via the first context protocol session 52A, and the second AICP response 50B is received from the remote AICP endpoint server via the second context protocol session 52B.

At the one or more ML models 82 included in the generative system 40, the one or more processing devices 16 are further configured to compute the generated output 66 based at least in part on the one or more AICP responses 50. The one or more processing devices 16 are further configured to output the generated output 66 to the user interface 60 as a response to the user's query 64. Additionally or alternatively, the one or more processing devices 16 may be configured to output the generated output 66 to some other computing process, such as a data logging process or an ML model training process.

In the example of FIG. 1, the storage device 22 of the computing device 12 further stores an AICP endpoint registry 70. The AICP endpoint registry 70 includes respective indications of one or more registered local applications 56A and registered remote applications 56B. A respective address 72 (e.g., an Internet protocol address) is specified in the AICP endpoint registry 70.

The AICP endpoint registry 70 further stores an application-programming interface (API) specification 78 of an API 86 respectively associated with the AICP endpoint 56. In the example of FIG. 1, the API specification 78 includes a registry of one or more actions 74 that are eligible for invocation at the AICP endpoint 56 by an API call. Each of the actions 74 is an API function that may be executed by the AICP endpoint server at which the AICP endpoint 56 is instantiated. The one or more actions 74 may be specified in a code format. The API specification 78 further includes a natural-language description 76 of the API 86 in the example of FIG. 1. The natural-language description 76 may include natural-language descriptions of the actions 74, and/or a summary of the API 86. Thus, the natural-language description 76 may provide an overview of the API 86 in order to guide the one or more ML models 82 during API call generation.

The one or more processing devices 16 are configured to perform registration 84 of the one or more local AICP endpoint servers 38 and the one or more remote AICP endpoint servers 36 to add those endpoint servers to the AICP endpoint registry 70 as AICP endpoints 56. The API specification of an AICP endpoint 56 may be computed during the registration 84.

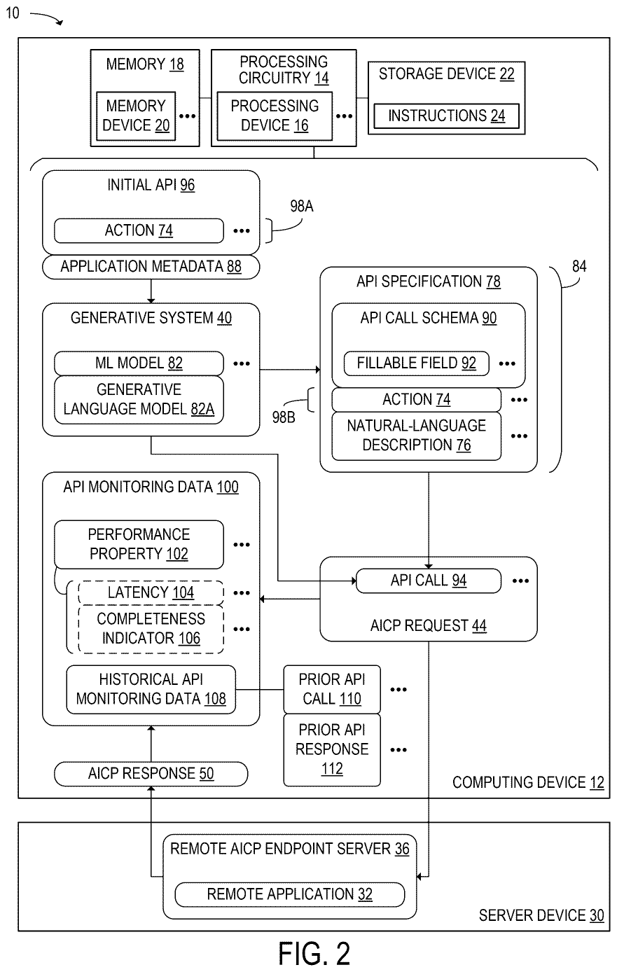

FIG. 2 schematically shows the computing system 10 in additional detail during computation of the API specification 78 and an API call 94. When the one or more processing devices 16 perform the registration 84, the one or more processing devices 16 are configured to receive an initial API 96 of a remote application 32 or a local application 34 from the AICP endpoint 56. The initial API 96 is associated with a remote application 32 in the example of FIG. 2. The initial API 96 includes a set 98A of actions 74, which may be the full set of actions 74 included in the API 86 of the application. Alternatively, the set 98A of actions 74 may have already been narrowed relative to the full API 86. The one or more processing devices 16 are further configured to receive application metadata 88 of the application executed at the AICP endpoint 56. The application metadata 88 may, for example, indicate one or more input types, output types, computing processes, and/or adjustable parameters of the application.

At least in part by executing the one or more ML models 82 included in the generative system 40, the one or more processing devices 16 are further configured to generate the API specification 78. For example, the API specification 78 may be generated at least in part at a generative language model 82A included in the generative system 40. As discussed above, the API specification 78 may include a registry of one or more available actions 74 with the application and may further include a natural language description 76 of the API 86. The one or more processing devices 16 may be configured to compute the API specification 78 at least in part by selecting, for inclusion in the API specification 78, a proper subset 98B of the set 98A of actions 74 included in the initial API 96. The one or more processing devices 16 may accordingly be configured to narrow the set 98A of actions 74 in order to avoid overloading the context window of a generative language model 82A included in the generative system 40.

In the example of FIG. 2, the API specification 78 further includes an API call schema 90 that has one or more fillable fields 92. The API call schema 90 may accordingly be used as a template with which an API call 94 is computed by populating the one or more fillable fields 92.

The one or more processing devices 16 are further configured to generate the API call 94 based at least in part on the API specification 78. The API call 94 is generated at least in part by executing the one or more ML models 82 using the API specification 78 as an input in order to fill the one or more fillable fields 92 of the API call schema 90. The API call 94 is included in an AICP request 44 in the example of FIG. 2. The one or more processing devices 16 are further configured to execute the API call 94 to communicate with an AICP endpoint 56 of the one or more AICP endpoints 56 included in the AICP endpoint registry 70. As discussed above, the AICP endpoint 56 is a remote AICP endpoint server 36 in the example of FIG. 2, but the AICP endpoint 56 that receives the AICP request 44 may be a local AICP endpoint server 38 in other examples.

Subsequently to outputting the AICP request 44, the one or more processing devices 16 are further configured to receive an AICP response 50 to the API call 94 from the AICP endpoint 56. The AICP response 50 may be used as an input to the generative system 40 with which a generated output 66 is computed as discussed above with reference to FIG. 1.

The one or more processing devices 16 are further configured to compute API monitoring data 100 that includes one or more performance properties 102 of executing the API call 94. For example, among the one or more performance properties 102, the API monitoring data 100 may include a latency 104 of the API call 94. The latency 104 may be computed as the amount of time elapsed between sending the AICP request 44 and receiving the AICP response 50. As another example, the API monitoring data 100 may include a completeness indicator 106 associated with the AICP response 50 received from the AICP endpoint 56. The completeness indicator 106 indicates whether the AICP response 50 includes each processing result requested from the AICP endpoint 56 in the AICP request 44. For example, if the AICP request 44 includes an API call 94 to an unavailable API 86, the completeness indicator 106 may indicate the resulting AICP response 50 as at least partially incomplete.

In some examples, the API monitoring data 100 includes historical API monitoring data 108 collected for a plurality of prior API calls 110 transmitted to the AICP endpoint 56. The historical API monitoring data 108 may specify respective performance properties 102 of the prior API calls 110 and prior API responses 112 received in response to those prior API calls 110. For example, the historical API monitoring data 108 may include respective latencies 104 and/or completeness indicators 106 associated with the prior API calls 110 and prior API responses 112.

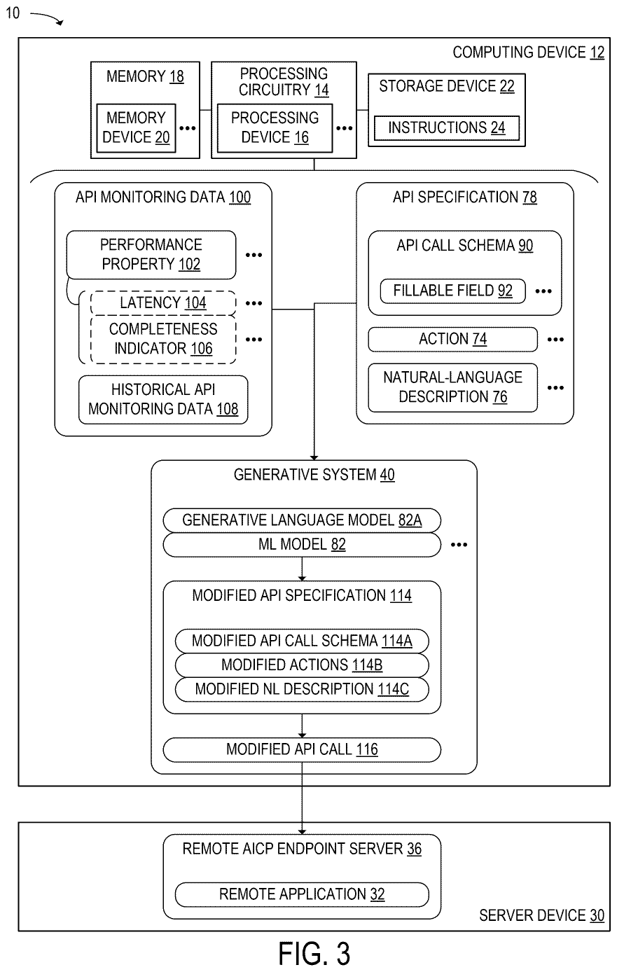

FIG. 3 schematically shows the computing system 10 during programmatic modification of the API specification 78. At least in part by executing the one or more ML models 82 included in the generative system 40, the one or more processing devices 16 are further configured to generate a modified API specification 114 based at least in part on the API specification 78 and the API monitoring data 100. For example, when computing the modified API specification 114, the one or more processing devices 16 may be configured to execute the generative language model 82A with inputs that include the API specification 78 and at least a portion of the API monitoring data 100. Other data may also be included in the prompt of the generative language model 82A in such examples, such as a prompt fragment instructing the generative language model 82A to modify the API specification 78 to reduce latency and/or increase response completeness.

The modified API specification 114 may include a modified API call schema 114A, one or more modified interactions 114B, and/or a modified natural-language description 114C. For example, a deprecated action 74 may be removed when a registry of modified interactions 114B is generated, or a newly added interaction may be added when computing the modified API specification 114. The one or more processing devices 16 may be further configured to recompute at least a portion of the natural-language description 114C in response to determining that the set of available actions 74 has changed.

At least in part by executing the one or more ML models 82, the one or more processing devices 16 are further configured to generate a modified API call 116 based at least in part on the modified API specification 114. The one or more processing devices 16 are further configured to execute the modified API call 116 to communicate with the AICP endpoint 56 in an AICP request 44. Accordingly, the one or more processing devices 16 are configured to interact with the AICP endpoint 56 using the modified API specification 114 that has been programmatically adjusted in a manner informed by the API monitoring data 100.

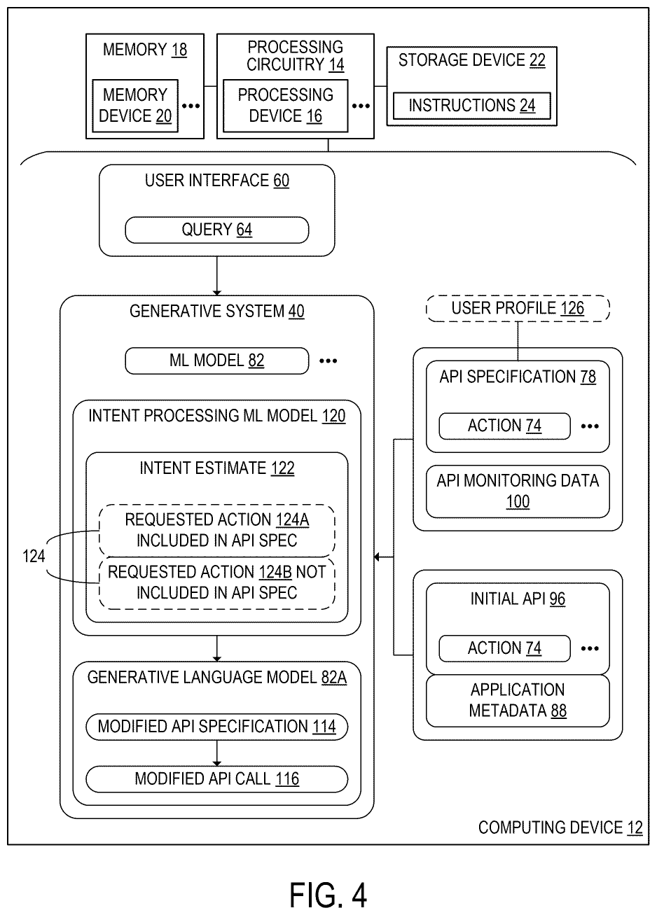

FIG. 4 schematically shows the computing system 10 in an example in which the one or more processing devices 16 are configured to compute the API call 94 based at least in part on a query 64 to the generative system 40 received at the user interface 60. The query 64 may be an instruction for the generative system 40 to perform a user-specified action 74 using capabilities of the remote application 32 or local application 34 executed at the AICP endpoint 56. The one or more processing devices 16 are further configured to generate the modified API specification 114 at the generative system 40 based at least in part on the query 64.

In the example of FIG. 4, the one or more ML models 82 included in the generative system 40 include an intent processing ML model 120 that is configured to compute an intent estimate 122 associated with the query 64. The intent processing ML model 120 may, in some examples, be a generative language model 82A that receives the query 64 and the API specification 78 as inputs, along with a prompt fragment that instructs the generative language model 82A to compute an intent estimate 122 of the query 64. In such examples, the intent estimate 122 may be a classification of the query 64 that identifies one or more requested actions 124 specified in the query 64. At the intent processing ML model 120, the one or more processing devices 16 may be configured to identify, as at least a portion of the intent estimate 122, one or more requested actions 124A that are included among the plurality of actions 74 in the API specification 78.

The intent processing ML model 120 may additionally or alternatively determine that the query 64 specifies a requested action 124B that is not included in the API specification 78. For example, the one or more processing devices 16 may determine that the requested action 124B does not match any of the actions 74 in the registry with a probability above a predefined probability threshold. In response to determining that the requested action 124B is not included in the API specification 78, the one or more processing devices 16 may be further configured to add the requested action 124B to the registry of the one or more actions 74 included in the API specification 78. The requested action 124B may be added to the registry in examples in which requested action 124B is included in the initial API 96 but not in the API specification 78. Thus, as shown in the example of FIG. 4, the initial API 96 may be used as an input to generative system 40 when performing intent-based modification of the API specification 78.

By estimating the user's requested actions 124, as shown in the example of FIG. 4, the one or more processing devices 16 may be configured to adjust the API specification 78 to include the types of actions 74 frequently requested by users of the generative system 40. In some examples, the API specification 78 may be associated with a user profile 126 of the user. In such examples, the one or more processing devices 16 may be configured to iteratively refine the API specification 78 to reflect the user's patterns of interaction with the generative system 40.

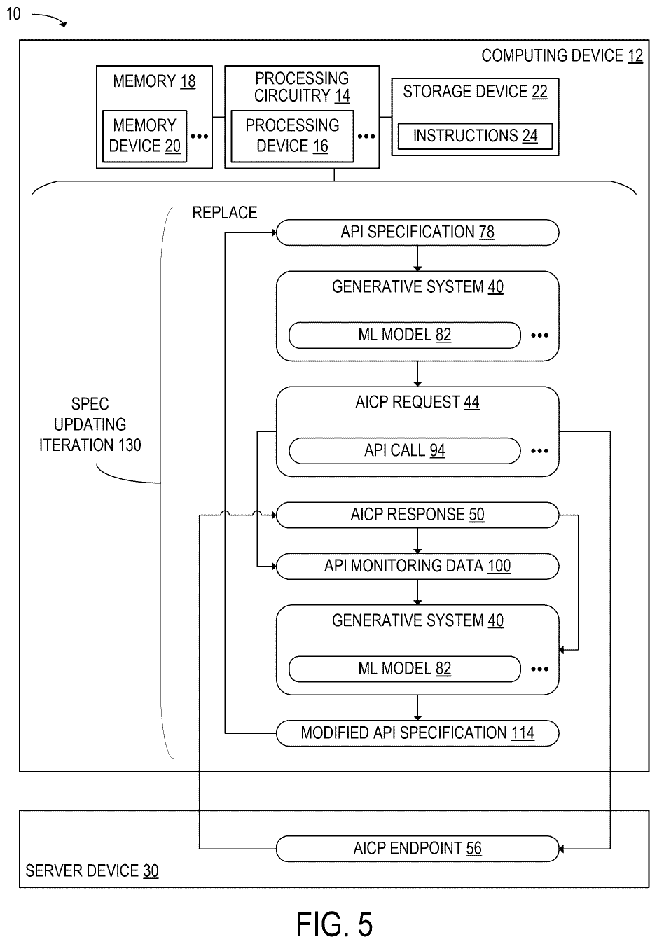

FIG. 5 schematically shows the computing system 10 in an example in which the one or more processing devices 16 are configured to programmatically execute a plurality of specification updating iterations 130. The specification updating iterations 130 each include performing respective modifications to the API specification 78 based at least in part on respective API monitoring data 100. In each of the specification updating iterations 130, according to the example of FIG. 5, the one or more processing devices 16 are configured to compute an AICP request 44 including an API call 94 at the generative system 40 using a current version of the API specification 78. The one or more processing devices 16 are further configured to transmit the AICP request 44 to the AICP endpoint 56 and receive an AICP response 50 from the AICP endpoint 56 in response to transmitting the AICP request 44. The one or more processing devices 16 are further configured to compute API monitoring data 100 associated with the exchange of the AICP request 44 and the AICP response 50, and to compute a modified API specification 114 at the generative system 40 based at least in part on the API monitoring data 100 and the current version of the API specification 78. The modified API specification 114 may replace the API specification 78 in a subsequent specification updating iteration 130. Thus, the API specification 78 may be iteratively modified over the course of a plurality of interactions between the generative system 40 and the AICP endpoint 56. Different specification updating iterations 130 may include communication with different AICP endpoints 56 in some examples.

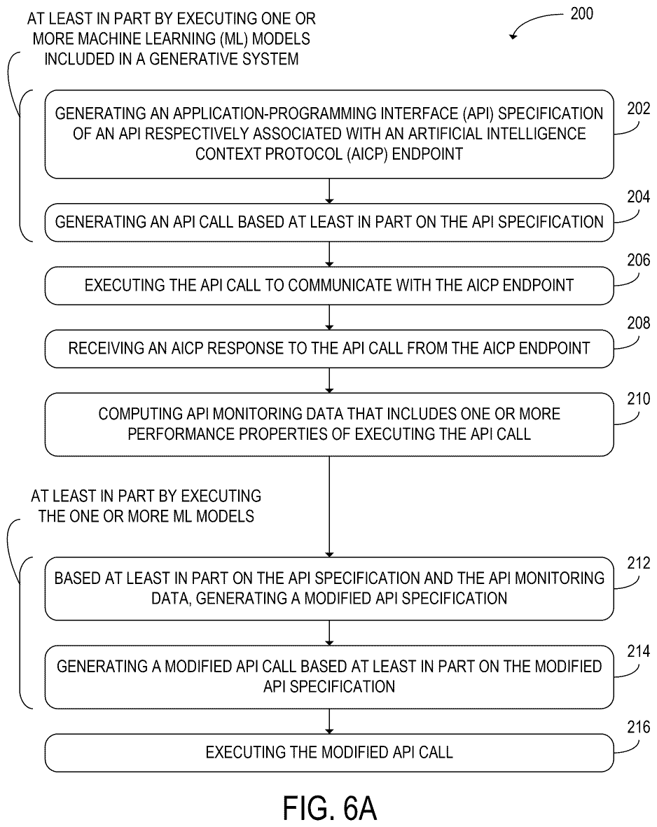

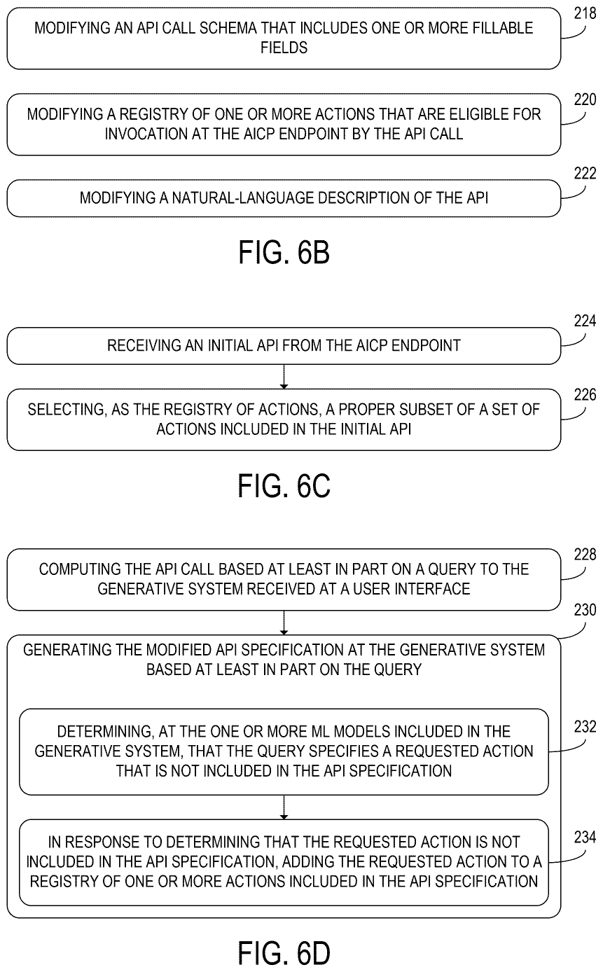

FIG. 6A shows a flowchart of a method 200 for use with a computing system to programmatically make API calls over an AICP. Steps 202 and 204 of the method 200, as shown in the example of FIG. 6A, are performed at least in part by executing one or more ML models included in a generative system. For example, steps 202 and 204 may be performed at least in part at one or more generative language models. At step 202, the method 200 includes generating an API specification of an API respectively associated with an AICP endpoint. The AICP endpoint may be a remote application executed at a remote AICP endpoint server or a local application executed at a local AICP endpoint server. The generative system may be executed at an AICP client that communicates with the endpoint server in an AICP session.

At step 204, the method 200 further includes generating an API call based at least in part on the API specification. At step 206, the method 200 further includes executing the API call to communicate with the AICP endpoint. The API call may be included in an AICP request transmitted from the AICP client to the AICP endpoint server. At step 208, the method 200 further includes receiving an AICP response to the API call from the AICP endpoint. At step 210, the method 200 further includes computing API monitoring data that includes one or more performance properties of executing the API call.

Steps 212 and 214 of the method 200 are also performed at least in part by executing the one or more ML models included in the generative system. At step 212, the method 200 further includes generating a modified API specification based at least in part on the API specification and the API monitoring data. At step 214, the method 200 further includes generating a modified API call based at least in part on the modified API specification. At step 216, the method 200 further includes executing the modified API call to communicate with the AICP endpoint. Thus, the API monitoring data is used to adjust the API specification that the one or more ML models utilize when programmatically generating API calls.

FIGS. 6B-6E show additional steps of the method 200 that may be performed in some examples. FIG. 6B shows example steps that may be performed when modifying the API specification at step 212. Step 218, as shown in FIG. 6B, may be performed in examples in which the API specification includes an API call schema that has one or more fillable fields. In such examples, at step 218, computing the modified API specification may include modifying the API call schema. Step 220 may be performed in examples in which the API specification includes a registry of one or more actions that are eligible for invocation at the AICP endpoint by the API call. In such examples, at step 220, computing the modified API specification may include modifying the registry of actions. Step 222 may be performed in examples in which the API specification includes a natural-language description of the API. In such examples, computing the modified API specification may include modifying the natural-language description.

In examples in which the API specification includes a registry of one or more actions, as discussed above, the steps of FIG. 6C may be performed. At step 224, the method 200 may further include receiving an initial API from the AICP endpoint. The initial API may be received prior to generating the API specification at step 202, and may, for example, be the full API of the remote application or local application. The initial API includes a set of actions that are eligible to invoke with API calls. At step 226, computing the API specification at step 202 may include selecting, as the registry of actions, a proper subset of a set of actions included in the initial API. Accordingly, the set of actions may be narrowed to obtain a subset that more conducive to reliable processing at the one or more ML models.

FIG. 6D shows additional steps of the method 200 that may be performed in some examples. At step 228, the method 200 may further include computing the API call based at least in part on a query to the generative system received at a user interface. The query may specify one or more actions for the generative system to perform, one or more of which may be offloaded to AICP endpoints. At step 230, the method 200 may further include generating the modified API specification at the generative system based at least in part on the query. Generating the modified API specification based at least in part on the query may include, at step 232, determining that the query specifies a requested action that is not included in the API specification. For example, step 232 may be performed at an intent processing ML model. At step 234, step 230 may further include adding the requested action to the registry of the one or more actions included in the API specification in response to determining that the requested action is not included in the specification.

FIG. 6E shows steps of the method 200 that may be performed in some examples when computing the API monitoring data at step 210. In some examples, at step 236, the method 200 may further include computing a latency of the API call. Additionally or alternatively, at step 238, step 210 may further include computing a completeness indicator associated with the AICP response received from the AICP endpoint. The completeness indicator may indicate whether the AICP response includes each processing result requested from the AICP endpoint in the AICP request. At step 240, the method 200 may further include computing historical API monitoring data collected for a plurality of prior API calls transmitted to the AICP endpoint. The historical API monitoring data may, for example, include respective latencies and/or completeness indicators of the prior API calls and corresponding AICP responses.

Using the systems and methods discussed above, an API specification associated with an API of an AICP endpoint is computed at a generative system. The API specification describes the API of the AICP endpoint in a manner that may allow one or more ML models (e.g., one or more generative language models) to generate API calls more easily and consistently, compared to using the full API as an input. For example, frequently called actions may be included in the API specification, whereas rarely used actions may be omitted. In addition, the API specification may be adjusted over the course of interactions between the AICP client, the application, and the user. The modification of the API specification is performed programmatically utilizing the code generation capabilities of one or more ML models included in the generative system. The adjustments to the API specification may further increase the usefulness of the API specification for programmatic API call generation. In addition, the API specification may be adjusted to match the user's patterns of interaction with the generative system.

The methods and processes described herein are tied to a computing system of one or more computing devices. In particular, such methods and processes can be implemented as a computer-application program or service, an application-programming interface (API), a library, and/or other computer-program product.

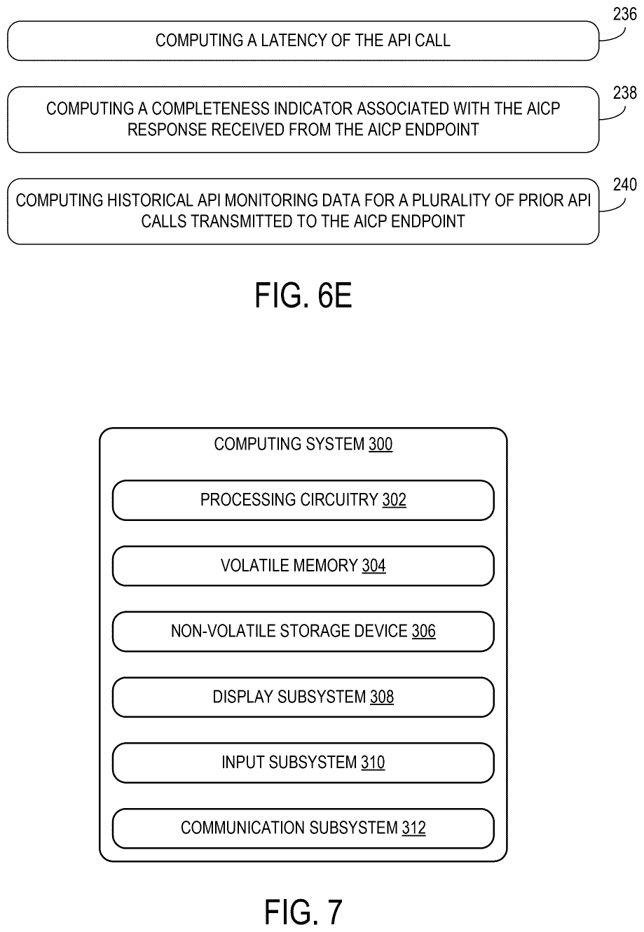

FIG. 7 schematically shows a non-limiting embodiment of a computing system 300 that can enact one or more of the methods and processes described above. Computing system 300 is shown in simplified form. Computing system 300 may instantiate the computing system 10 discussed above with reference to FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 7.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to, at least in part by executing one or more machine learning (ML) models included in a generative system, generate an application-programming interface (API) specification of an API respectively associated with an artificial intelligence context protocol (AICP) endpoint. At least in part by executing the one or more ML models, the one or more processing devices are further configured to generate an API call based at least in part on the API specification. The one or more processing devices are further configured to execute the API call to communicate with the AICP endpoint. The one or more processing devices are further configured to receive an AICP response to the API call from the AICP endpoint. The one or more processing devices are further configured to compute API monitoring data that includes one or more performance properties of executing the API call. At least in part by executing the one or more ML models, based at least in part on the API specification and the API monitoring data, the one or more processing devices are further configured to generate a modified API specification. The one or more processing devices are further configured to generate a modified API call based at least in part on the modified API specification at least in part by executing the one or more ML models. The one or more processing devices are further configured to execute the modified API call. The above features may have the technical effect of computing an API specification that allows the one or more ML models to perform consistent, accurate API call generation when using the API specification as an input.

According to this aspect, the API specification may include an API call schema that has one or more fillable fields. The one or more processing devices may be configured to compute the modified API specification at least in part by modifying the API call schema. The above features may have the technical effect of generating API calls according to a schema that is modified based at least in part on the API monitoring data to achieve intended performance properties.

According to this aspect, the API specification may include a registry of one or more actions that are eligible for invocation at the AICP endpoint by the API call. The one or more processing devices may be configured to compute the modified API specification at least in part by modifying the registry of actions. The above features may have the technical effect of allowing the generative system to refer to a set of available actions when generating API calls.

According to this aspect, the one or more processing devices may be further configured to receive an initial API from the AICP endpoint. The one or more processing devices may be further configured to compute the API specification at least in part by selecting, as the registry of actions, a proper subset of a set of actions included in the initial API. The above features may have the technical effect of narrowing the set of actions to a subset that fits in a context window of an ML model while retaining actions that the generative system has a high probability of invoking in an API call.

According to this aspect, the API specification may include a natural-language description of the API. The one or more processing devices may be configured to compute the modified API specification at least in part by modifying the natural-language description. The above features may have the technical effect of providing an overview of the API to the one or more ML models in order to guide API call generation.

According to this aspect, the one or more processing devices may be configured to compute the API call based at least in part on a query to the generative system received at a user interface. The one or more processing devices may be further configured to generate the modified API specification at the generative system based at least in part on the query. The above features may have the technical effect of performing the API call in response to user input.

According to this aspect, the one or more processing devices may be further configured to determine, at the one or more ML models included in the generative system, that the query specifies a requested action that is not included in the API specification. In response to determining that the requested action is not included in the API specification, the one or more processing devices may be further configured to add the requested action to a registry of one or more actions included in the API specification. The above features may have the technical effect of adding an action to the API specification in response to the user requesting an action that is not already included.

According to this aspect, the API monitoring data may include a latency of the API call. The above features may have the technical effect of prompting the generative system to reduce API call latency when modifying the API specification.

According to this aspect, the API monitoring data may include a completeness indicator associated with the AICP response received from the AICP endpoint. The above features may have the technical effect of prompting the generative system to modify the API specification in order to increase AICP response completeness.

According to this aspect, the API monitoring data may include historical API monitoring data collected for a plurality of prior API calls transmitted to the AICP endpoint. The above features may have the technical effect of accounting for the performance properties of a plurality of API calls when computing the modified API specification.

According to this aspect, the one or more processing devices may be configured to programmatically execute a plurality of specification updating iterations that each include performing respective modifications to the API specification based at least in part on respective API monitoring data. The above features may have the technical effect of iteratively adjusting the API specification to achieve intended performance properties.

According to another aspect of the present disclosure, a method for use with a computing system is provided. The method includes, at least in part by executing one or more machine learning (ML) models included in a generative system, generating an application-programming interface (API) specification of an API respectively associated with an artificial intelligence context protocol (AICP) endpoint. At least in part by executing the one or more ML models, the method further includes generating an API call based at least in part on the API specification. The method further includes executing the API call to communicate with the AICP endpoint. The method further includes receiving an AICP response to the API call from the AICP endpoint. The method further includes computing API monitoring data that includes one or more performance properties of executing the API call. At least in part by executing the one or more ML models, the method further includes generating a modified API specification based at least in part on the API specification and the API monitoring data. The method further includes generating a modified API call based at least in part on the modified API specification at least in part by executing the one or more ML models. The method further includes executing the modified API call. The above features may have the technical effect of computing an API specification that allows the one or more ML models to perform consistent, accurate API call generation when using the API specification as an input.

According to this aspect, the API specification may include an API call schema that has one or more fillable fields. Computing the modified API specification may include modifying the API call schema. The above features may have the technical effect of generating API calls according to a schema that is modified based at least in part on the API monitoring data to achieve intended performance properties.

According to this aspect, the API specification may include a registry of one or more actions that are eligible for invocation at the AICP endpoint by the API call. Computing the modified API specification may include modifying the registry of actions. The above features may have the technical effect of allowing the generative system to refer to a set of available actions when generating API calls.

According to this aspect, the method may further include receiving an initial API from the AICP endpoint. The method may further include computing the API specification at least in part by selecting, as the registry of actions, a proper subset of a set of actions included in the initial API. The above features may have the technical effect of narrowing the set of actions to a subset that fits in a context window of an ML model while retaining actions that the generative system has a high probability of invoking in an API call.

According to this aspect, the API specification may include a natural-language description of the API. Computing the modified API specification may includes modifying the natural-language description. The above features may have the technical effect of providing an overview of the API to the one or more ML models in order to guide API call generation.

According to this aspect, the method may further include computing the API call based at least in part on a query to the generative system received at a user interface. The method may further include generating the modified API specification at the generative system based at least in part on the query. The above features may have the technical effect of performing the API call in response to user input.

According to this aspect, the API monitoring data may include a latency of the API call. The above features may have the technical effect of prompting the generative system to reduce API call latency when modifying the API specification.

According to this aspect, the API monitoring data may include a completeness indicator associated with the AICP response received from the AICP endpoint. The above features may have the technical effect of prompting the generative system to modify the API specification in order to increase AICP response completeness.

According to another aspect of the present disclosure, a computing system is provided, including one or more processing devices configured to, at least in part by executing one or more machine learning (ML) models included in a generative system, receive an initial application-programming interface (API) from an artificial intelligence context protocol (AICP) endpoint. Based at least in part on the initial API, at least in part by executing the one or more ML models, the one or more processing devices are further configured to generate an application-programming interface (API) specification associated with the AICP endpoint. The API specification may include a registry of interactions that are eligible for invocation in respective API calls. The one or more processing devices are further configured to generate an API call based at least in part on the API specification at least in part by executing the one or more ML models. The one or more processing devices are further configured to execute the API call to communicate with the AICP endpoint. The one or more processing devices are further configured to receive an AICP response to the API call from the AICP endpoint. At the one or more ML models included in the generative system, the one or more processing devices are further configured to compute a generated output based at least in part on the AICP response. The one or more processing devices are further configured to output the generated output. The above features may have the technical effect of computing an API specification that allows the one or more ML models to perform consistent, accurate API call generation when using the API specification as an input.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
at least in part by executing one or more machine learning (ML) models included in a generative system:
generate an application-programming interface (API) specification of an API respectively associated with an artificial intelligence context protocol (AICP) endpoint; and
generate an API call based at least in part on the API specification;
execute the API call to communicate with the AICP endpoint;
receive an AICP response to the API call from the AICP endpoint;
compute API monitoring data that includes one or more performance properties of executing the API call;
at least in part by executing the one or more ML models:
based at least in part on the API specification and the API monitoring data, generate a modified API specification; and
generate a modified API call based at least in part on the modified API specification; and
execute the modified API call.

2. The computing system of claim 1, wherein:
the API specification includes an API call schema that has one or more fillable fields; and
the one or more processing devices are configured to compute the modified API specification at least in part by modifying the API call schema.

3. The computing system of claim 1, wherein:
the API specification includes a registry of one or more actions that are eligible for invocation at the AICP endpoint by the API call; and
the one or more processing devices are configured to compute the modified API specification at least in part by modifying the registry of actions.

4. The computing system of claim 3, wherein the one or more processing devices are further configured to:
receive an initial API from the AICP endpoint; and
compute the API specification at least in part by selecting, as the registry of actions, a proper subset of a set of actions included in the initial API.

5. The computing system of claim 1, wherein:
the API specification includes a natural-language description of the API; and
the one or more processing devices are configured to compute the modified API specification at least in part by modifying the natural-language description.

6. The computing system of claim 1, wherein the one or more processing devices are configured to:
compute the API call based at least in part on a query to the generative system received at a user interface;
generate the modified API specification at the generative system based at least in part on the query.

7. The computing system of claim 6, wherein the one or more processing devices are further configured to:
determine, at the one or more ML models included in the generative system, that the query specifies a requested action that is not included in the API specification; and
in response to determining that the requested action is not included in the API specification, add the requested action to a registry of one or more actions included in the API specification.

8. The computing system of claim 1, wherein the API monitoring data includes a latency of the API call.

9. The computing system of claim 1, wherein the API monitoring data includes a completeness indicator associated with the AICP response received from the AICP endpoint.

10. The computing system of claim 1, wherein the API monitoring data includes historical API monitoring data collected for a plurality of prior API calls transmitted to the AICP endpoint.

11. The computing system of claim 1, wherein the one or more processing devices are configured to programmatically execute a plurality of specification updating iterations that each include performing respective modifications to the API specification based at least in part on respective API monitoring data.

12. A method for use with a computing system, the method comprising:
at least in part by executing one or more machine learning (ML) models included in a generative system:
generating an application-programming interface (API) specification of an API respectively associated with an artificial intelligence context protocol (AICP) endpoint; and
generating an API call based at least in part on the API specification;
executing the API call to communicate with the AICP endpoint;
receiving an AICP response to the API call from the AICP endpoint;
computing API monitoring data that includes one or more performance properties of executing the API call;
at least in part by executing the one or more ML models:
based at least in part on the API specification and the API monitoring data, generating a modified API specification; and
generating a modified API call based at least in part on the modified API specification; and
executing the modified API call.

13. The method of claim 12, wherein:
the API specification includes an API call schema that has one or more fillable fields; and
computing the modified API specification includes modifying the API call schema.

14. The method of claim 12, wherein:
the API specification includes a registry of one or more actions that are eligible for invocation at the AICP endpoint by the API call; and
computing the modified API specification includes modifying the registry of actions.

15. The method of claim 14, further comprising:
receiving an initial API from the AICP endpoint; and
computing the API specification at least in part by selecting, as the registry of actions, a proper subset of a set of actions included in the initial API.

16. The method of claim 12, wherein:
the API specification includes a natural-language description of the API; and
computing the modified API specification includes modifying the natural-language description.

17. The method of claim 12, further comprising:
computing the API call based at least in part on a query to the generative system received at a user interface;
generating the modified API specification at the generative system based at least in part on the query.

18. The method of claim 12, wherein the API monitoring data includes a latency of the API call.

19. The method of claim 12, wherein the API monitoring data includes a completeness indicator associated with the AICP response received from the AICP endpoint.

20. A computing system comprising:
one or more processing devices configured to:
at least in part by executing one or more machine learning (ML) models included in a generative system:
receive an initial application-programming interface (API) from an artificial intelligence context protocol (AICP) endpoint;
based at least in part on the initial API, generate an application-programming interface (API) specification associated with the AICP endpoint, wherein the API specification includes a registry of interactions that are eligible for invocation in respective API calls;
generate an API call based at least in part on the API specification;
execute the API call to communicate with the AICP endpoint;
receive an AICP response to the API call from the AICP endpoint;
at the one or more ML models included in the generative system, compute a generated output based at least in part on the AICP response; and
output the generated output.
